(19) United States
(12) Patent Application Publication
(10) Pub. No.: US 2003/0208380 A1
(43) Pub. Date: Nov. 6, 2003

(54) System and method for delivering comprehensive health care

(76) Inventor: Sarah L. Honeycutt, Reno, NV (US)

Correspondence Address: Brian C. Kunzler, Suite 425, 10 West 100 South, Salt Lake City, UT, 84101, US

(21) Appl. No.: 10/430,641

(22) Filed: May 6, 2003

Related U.S. Application Data
(60) Provisional application No. 60/378,274, filed on May 6, 2002.

(51) Int. Cl. G06F 17/60

(52) U.S. Cl. 705/2

(57) ABSTRACT

A system and method for delivering comprehensive health care to a patient is provided. The system and method include forming a cooperative relationship between a medical doctor and at least one alternative health care provider. The cooperative relationship motivates the medical doctor and the alternative health care providers to cooperate to serve the patient. The medical doctor and the alternative health care providers consult with patients in a common facility that enables a patient to selectively consult either the medical doctor or the alternative health care providers to address the patient's needs. Together, the patient and medical doctor or alternative health care provider formulate a regimen for the patient to achieve complete health. In addition, a computer system is provided that enforces business rules of the cooperative relationship and allows the patient to repeatedly visit the medical doctor or one of the alternative health care providers for following and refining the patient's regimen.

### RELATED APPLICATIONS

This application is a continuation-in-part of and claims priority to U.S. Provisional Patent Application No. 60/378,274, filed on May 6, 2002 and entitled “SYSTEM FOR PROVIDING MEDICAL AND HOLISTIC HEALTH CARE IN A COORDINATED AND COOPERATIVE MULTI-HEALTH CARE ENVIRONMENT.”

### BACKGROUND OF THE INVENTION

1. The Field of the Invention

The invention relates to health care services. Specifically, the invention relates to systems and methods for comprehensive health care centered on the patient.

2. The Relevant Art

Most people consider health a top priority. Generally, health is defined as freedom from disease or pain and a condition of being sound in mind, body, and spirit. A profession of medical doctors has developed to provide relief from disease and pain. In addition, other disciplines have developed to assist patients in developing a sound mind, body, and spirit. These disciplines include nutritionists, psychologists, exercise physiologists, and the like.

Achieving complete health and wellness requires a close relationship and cooperation between the patient and the health care professional. Complete health often requires work on the part of the health care professional and the patient. The relationship requires the patient to trust that the recommended treatment will bring the desired health benefit.

Unfortunately, patients are loosing trust in conventional medical doctors' ability to provide comprehensive health care. Conventional medicine is moderately successful in treating disease and pain in patients. Generally, the medical doctor analyzes the symptoms to determine a cause. Once one or more causes are indicated, the doctor prescribes medicine or a procedure to resolve the disease or pain. If signs of the disease or pain are alleviated, the patient is considered cured and healthy.

The human body, however, is very complex. Detectable symptoms may have a variety of single or contributing causes. Prescribed medicines may only treat the symptom—such as pain—but not ever addressing the cause. Other contributing causes may cause similar symptoms to recur. This failure to address the cause and/or provide a long-term solution causes patients to become discouraged and lose faith in the conventional medical system. Alternatively, if the medicine does treat the cause or alleviate the symptoms for an extended period of time, the patient may become dependent on medicines and neglect to do his/her part to improve his/her own health.

The conventional health care system in which the doctors operate also causes patients to lose confidence in medical doctors. Today's health care system is overburdened with paper work, policies, too many patients, and too few doctors. As a consequence, conventional medical doctors are forced to focus on only the most immediate and obvious needs of the patient, such as disease and pain. The doctor has very little time with each patient. Little attention is spent on prescribing a health regimen for a patient or addressing preventative health care measures.

Furthermore, the bureaucracy, financial pressures, and paperwork presented to patients by the doctors and insurance providers causes patients to feel controlled, and that the patient has little say regarding his/her own health. The patient feels like a number, an object that is directed from one doctor to a specialist, or from one facility to another facility. Consequently, the patient tends to avoid visiting the medical doctor, unless the patient has an acute condition.

Unfortunately, cultural biases and financial disincentives may force patients to work within the current medical system or go without health care. Patients may avoid alternative forms of medical care because of a common misperception that health insurance providers are unwilling to pay for office visits and treatments, even though the patient may receive more effective and personal care.

Many different alternative health care providers exist, including doctors of naturopathy, colon hydrotherapists, nutritionists, psychologists, massage therapists, exercise physiologists, chiropractors, acupuncturists, and the like. These health care professionals are quickly gaining respect among the general public. Generally, the methodologies and treatments available from these alternative health care providers are different from the typical allopathic approaches, though, each alternative health care methodology is complementary of the others including those of a traditional medical doctor.

Unfortunately, historical biases, financial pressures, and the like create barriers that prevent easy access to these alternative health care providers by patients. Conventional doctors may consider the alternative health care providers to be unprofessional, or non-scientific. The public, however, continues to visit and instill greater confidence in these alternative health care providers not withstanding the current barriers.

Accordingly, what is needed is a system and method for providing comprehensive health care that includes the collaborative benefits of a medical doctor and alternative health care providers working together for the benefit of the patient. What is needed is a system and method that encourages and facilitates a cooperative relationship between a conventional medical doctor and one or more alternative health care providers. Furthermore, what is needed is a system and method that enables the patient to become more involved and to have more control regarding treatments prescribed. In addition, what is needed is a system and method that leverages the professional opinions of a conventional medical doctor and one or more alternative health care providers to produce a comprehensive patient health regimen. What is further needed is a system and method that encourage and support a patient in making lifestyle changes that affect the mind, body, and spirit of the individual. Finally, what is needed is a system and method that resolves the problems in the current state of the art by providing comprehensive health care through a common facility.

### SUMMARY OF THE INVENTION

The various elements of the present invention have been developed in response to the present state of the art, and in particular, in response to the problems and needs in the art that have not yet been fully solved by currently available healthcare delivery systems. Accordingly, the present invention provides an improved system and method for delivering comprehensive health care to patients.

In one aspect of the present invention, a method is provided for delivering comprehensive health care to patients. The method begins by forming a cooperative relationship between a medical doctor and at least one alternative health care provider for addressing a patient's needs. Preferably, the cooperative relationship comprises a formal contract between a medical doctor and at least one alternative health care provider to work together to resolve a patient's concern.

In one aspect, the medical doctor and at least one alternative health care provider conduct regular conferences to discuss the needs of specific patients and the potential solutions available from the medical doctor or one or more alternative health care providers. In one embodiment, the medical doctor and at least one alternative health care provider propose changes to a patient's regimen that may later be ratified by the patient.

In another aspect, the medical doctor enters the cooperative relationship with two or more alternative health care providers. Preferably, the alternative health care providers are trained to practice exclusively within his/her own alternative health care discipline.

In an alternative embodiment, the cooperative relationship may comprise an oral agreement between the medical doctor and at least one alternative health care provider. The cooperative relationship includes an agreement to share professional opinions, patient information, a common facility, and to refer the patient to the medical doctor or one of the alternative health care providers based on the desires and/or needs of the patient. The cooperative relationship may also include an agreement to defer to the patient's desires in determining a treatment and/or regimen. Furthermore, the cooperative relationship preferably includes an agreement to meet periodically to discuss the particular needs of all the patients being seen by the medical doctor or one of the alternative health care providers.

In addition, the method enables a patient to selectively consult the medical doctor or one of the alternative health care providers to address the patient's needs. Preferably, the services of the medical doctor and one or more alternative health care providers are made available in a single facility. The patient is educated as to the services available from the medical doctor and each of the alternative health care providers. The patient may then select the medical doctor or one of the alternative health care providers for a consultation. The patient consults with the selected medical doctor or alternative health care provider in a timely manner. In certain embodiments, an advisor may recommend a consultation with a specific medical doctor or alternative health care provider to the patient.

Additionally, following the consultation, the selected medical doctor or alternative health care provider may prescribe a regimen for the patient. The regimen may include an educational class, a self-directed treatment such as exercise, a professional treatment such as surgery, or a subsequent consultation with the same medical doctor or alternative health care provider. The subsequent consultation included in the regimen may also include a consultation with the medical doctor or another alternative health care provider other than the provider originally selected by the patient. The medical doctor and/or the alternative health care providers encourage the patient to follow the prescribed regimen. In response to patient desires, the medical doctor or one of the alternative health care providers may modify the prescribed regimen.

In one aspect, the present invention includes a computer system configured to provide for delivery of comprehensive health care, allowing a patient to choose to consult a medical doctor and one or more alternative health care providers. The computer system includes a storage module that stores patient information regarding each consultation, fees charged, a diagnosis, a regimen prescribed, and the like. Preferably, access to the patient information is password protected. Based on patient desires, the patient information may be restricted solely to the patient. In certain embodiments, the patient information may only indicate that a confidential diagnosis or description was made, but not allow a user to determine what the confidential diagnosis or description is.

An input module is configured to allow for maintaining the patient information. An output module allows the medical doctor and one or more alternative health care providers to share and review patient information. A control module communicates with the input module, the output module, and the storage module, to manage the patient information in support of a cooperative relationship between the medical doctor and the one or more alternative health care providers.

The various elements and aspects of the present invention provide a novel system and method for delivering comprehensive health care that allows a patient to consult a medical doctor or an alternative health care provider. These and other features and advantages of the present invention will become more fully apparent from the following description and appended claims, or may be learned by the practice of the invention as set forth hereinafter.

### BRIEF DESCRIPTION OF THE DRAWINGS

In order that the manner in which the advantages of the invention will be readily understood, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram illustrating relationships between a patient, a medical doctor, and an alternative health care provider according to one embodiment of the present invention;

FIG. 2 is a block diagram illustrating one embodiment of a computer system capable of implementing the present invention;

FIG. 3 is a block diagram illustrating one embodiment of a controller for the computer system of FIG. 2;

FIG. 4 is a block diagram illustrating one embodiment of patient information according to the present invention;

FIG. 5 is a flow chart illustrating a method for delivering comprehensive health care according to one embodiment of the present invention; and

FIG. 6 is a flow chart illustrating a method for servicing a patient presented for health care services according to one embodiment of the present invention.

### DETAILED DESCRIPTION OF THE INVENTION

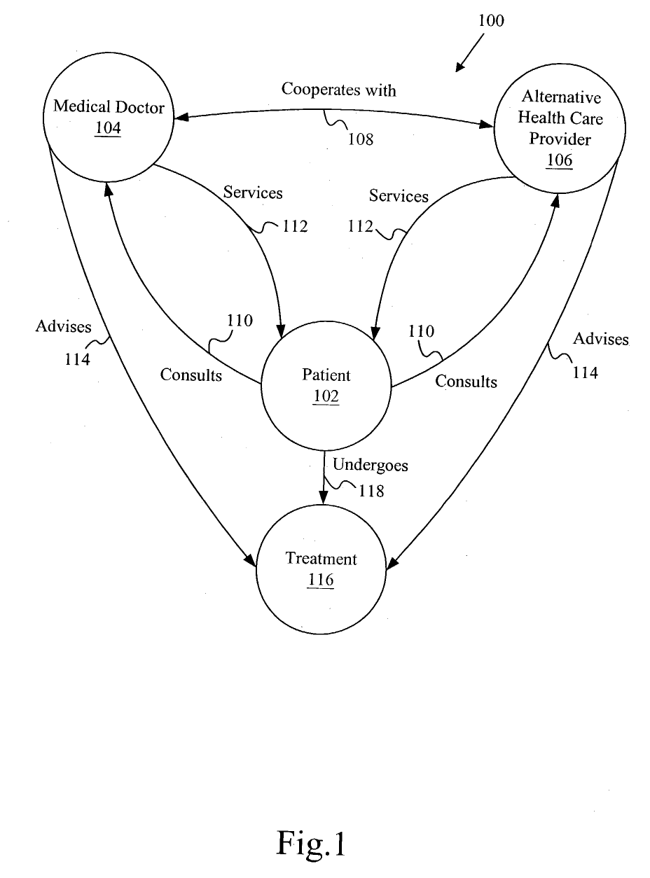

It will be readily understood that the components of the present invention, as generally described and illustrated in the Figures herein, may be arranged and designed in a wide variety of different configurations. Thus, the following more detailed description of the embodiments of the system and method of the present invention, as represented in FIGS. 1 through 6, is not intended to limit the scope of the invention, as claimed, but is merely representative of selected embodiments of the invention.

Many of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Certain modules, well known to those of skill in the art, may not be specifically illustrated or discussed, for clarity. Similarly, operational data may be identified and illustrated herein within modules, may be embodied in any suitable form, and may be organized within any suitable type of data structure. The operational data may be collected as a single data set, may be distributed over different locations, including over different storage devices, and may exist, at least partially, merely as electronic signals on a system or network.

The illustrated embodiments of the invention will be best understood by reference to the drawings, wherein like parts are designated by like numerals throughout. Those of ordinary skill in the art will, of course, appreciate that various modifications to the devices, systems and processes illustrated in FIGS. 1 through 6 may readily be made without departing from the essential characteristics of the invention. Thus, the following description is intended only by way of example, and simply illustrates certain selected embodiments of devices, systems and processes that are consistent with the invention as claimed herein.

FIG. 1 illustrates relationships between a patient, a medical doctor, and at least one alternative health care provider for delivering comprehensive health care according to one embodiment of the present invention. For clarity, a single alternative health care is provider may be referred to herein. Those of skill in the art, however, will recognize that where one alternative health care provider is described, one or more alternative health care providers may be substituted.

Preferably, the present invention provides a business method for delivering comprehensive health care that centers on the patient 102. The present invention delivers health care services to a patient 102 in such a manner that the patient 102 is able to select whether to consult with a medical doctor 104 or an alternative health care provider 106.

The patient 102 is a person that has a particular need or concern. Often, the patient's need is directly related to a health condition. For example, the patient may have a migraine headache or a broken arm. Alternatively, the patient may have a concern about his/her health that does not show immediate symptoms or presently cause pain or discomfort. For example, the patient may be concerned about how to control his/her weight. In yet another alternative, the patient may see hallucinations or have trouble concentrating. In another example, the patient may desire to learn how to organize a specific exercise program. The types of concerns and needs the patient may have vary considerably.

A business method according to the present invention begins by forming a cooperative relationship 108 between a medical doctor 104 and an alternative health care provider 106. Preferably, a plurality of alternative health care providers 106 form a cooperative relationship 108 with the medical doctor 104.

A medical doctor 104 is one who has completed the necessary education and who holds the necessary credentials to practice medicine within a particular jurisdiction. Preferably, the medical doctor 104 is one who is authorized to treat patients using conventional medical methods and medicines available in most developed countries, such as the United States. In a preferred embodiment, the medical doctor 104 is trained to handle general medical and health related conditions. In other words, the medical doctor 104 is a general practitioner.

An Alternative Health Care Provider 106 (AHCP) is anyone who provides treatments or services relating to a person's health that are different from those provided by a medical doctor 104. The AHCP 106 may or may not be licensed in the particular jurisdiction. Preferably, the doctor 104 and AHCPs 106 hold all the required licenses and highest credentials offered in the particular jurisdiction. Representative examples of AHCPs 106 include but are not limited to a doctor of naturopathy, a colon hydrotherapist, a nutritionist, a psychologist, a massage therapist, an exercise physiologist, a chiropractor, an acupuncturist, and the like. In certain embodiments, a plurality of AHCPs 106 engage in the cooperative relationship 108 with the medical doctor 104. In these embodiments, the doctor 104 and AHCPs 106 preferably provide complementary health care services. Certain alternative health care services may directly involve the body of a patient 102, while others involve the patient's mind, soul, or lifestyle.

The cooperative relationship 108 may be embodied in various forms. In one embodiment, the cooperative relationship is an oral agreement between the medical doctor 104 and the one or more AHCPs 106 to share patients, professional opinions, patient information, and a common facility. Of course, the oral agreement may also include other issues such as sharing in medical malpractice liability, common work schedules, common insurance providers, and the like. In an alternative embodiment, the cooperative relationship 108 may comprise a formal agreement such as a contract between the medical doctor 104 and the AHCP 106. The contract may specifically state the terms and conditions of the agreement between the medical doctor 104 and the AHCP 106 to cooperate for the benefit of the patient 102.

Preferably, the cooperative relationship 108 is tailored to substantially favor the medical doctor 104 and the AHCPs 106 equally for the benefit of the patient 102. In certain embodiments, the cooperative relationship 108 is embodied in a business relationship such as a partnership, Limited Liability Company (LLC), corporation, or the like. In one embodiment, the cooperative relationship 108 may include an incentive program for the doctor 104 to cooperate with-the AHCP 106. For example, for each patient 102 referred from the doctor 104 to an AHCP 106, the doctor 104 may receive a portion of the fees charged by the referred AHCP 106, if and when the patient 102 consults with the referred AHCP 106.

As mentioned above, the cooperative relationship 108 preferably includes an agreement that the doctor 104 and AHCP 106 share a common facility. The common facility provides convenience and instills confidence in the patient 102. In a preferred embodiment, the patient 102 visits the common facility to address one or more concerns. The cooperative relationship 108 preferably minimizes competition between the doctor 104 and AHCP 106 for patients 102. The common facility and cooperative relationship 108 enables a new patient 102 to select whether to consult with the doctor 104 or one of the AHCPs 106. Preferably, the new patient 102 is educated about the services available from the doctor 104 and one of the AHCPs 106 prior to making an initial selection for a consultation. For example, the patient 102 may view a live or pre-recorded orientation.

Once a patient 102 has determined to consult with either the doctor 104 or one of the AHCPs 106 an appointment is scheduled. For clarity, the doctor 104 or AHCP 106 selected will be referred to collectively hereinafter as the provider 104, 106. Next, the patient 102 waits for the appointment. The appointment may be for within a few minutes or a few days.

At the appointment, the patient 102 consults 110 with the selected provider 104, 106. The selected provider 104, 106 seeks to ensure that the patient 102 feels comfortable explaining his/her concern and seeking the selected provider's advice and assistance. Preferably, the cooperative relationship 108 includes an emphasis that the selected providers 104, 106 defer to the patient's desires. The selected provider 104, 106 seeks to communicate that the patient 102 is in control and that the doctor 104 and other AHCPs 106 are a team of experts available as a resource to the patient 102.

The selected provider 104, 106 provides services 112 for the patient 102 that are consistent with the selected provider's discipline and expertise. The nature of the consultation 110 and the services 112 rendered depends in large part on the discipline of the selected provider 104, 106. For example, the medical doctor 104 may ask a series of questions and conduct an examination of the condition of the patient's body. Alternatively, a psychologist 106 may conduct a conversation with the patient 102.

Furthermore, the services 112 may include a series of physical, mental, psychological, biological, and physiological tests. Preferably, as a result of the consultation, the selected provider 104, 106 is able to form a diagnosis. In certain circumstances, the provider 104, 106 requires subsequent consultations or tests prior to forming a diagnosis. The selected provider 104, 106 records results of each consultation 110. Preferably, basic information about the patient 102 is also recorded so that the patient 102 can easily return for subsequent consultations 110 and/or treatments.

Preferably, based on one or more consultations 110, the selected provider 104, 106, forms a professional opinion and provides advice 114 to the patient 102. Typically, the advice 114 includes prescribing some form of treatment 116 that will address the patient's concern and/or improve the health of the patient 102. Alternatively, the advice 114 may comprise an affirmation of the patient's 102 current lifestyle and habits and confirmation that the patient is doing all that is necessary to maintain health, as it relates to the discipline of the selected provider 104, 106. For example, although a patient 102 decided to consult a psychologist 106, the psychologist 106 may acknowledge that the patient 102 is doing all that is necessary to maintain proper mental health.

Typically, the selected provider 104, 106 advises 114 a treatment 116 within the discipline of the selected provider 104, 106. For example, the acupuncturist 106 may advise 114 acupuncture to treat pain in a patient's foot. The treatment 116 may comprise a professional treatment performable during the same office visit or at a special facility such as a hospital. Alternatively, the treatment 116 may include a self-directed treatment. A self-directed treatment is one conducted by the patient 102 without the aide of the selected provider 104, 106. For example, a self-directed treatment may include daily exercise.

The types of treatments 116 the doctor 104 or AHCPs 106 may prescribe are varied. The treatment 116 may include a prescribed drug, herb, diet, or the like. In certain embodiments, the treatment 116 includes educating the patient 102. The education may comprise classes on healthy food preparation, how to relieve stress, how to perform a massage, and the like.

The treatment 116 may also comprise a variety of methods or procedures. For example, the doctor 104 may advise 114 a surgical procedure to clear clogged arteries. In addition, because of the unique cooperative relationship 108, the doctor 104 may also advise 114 that the patient 102 subsequently consult a nutritionist 106 to assist the patient 102 in making changes in his/her diet that will prevent future clogging of the arteries. In another example, a chiropractor 106 may advise 114 that the patient 102 consult the massage therapist 106 to receive a massage to relax muscles adversely affecting the patient's posture. Preferably, the treatment 116 prescribed is consistent with the patient's needs, desires, and condition as assessed by the selected provider 104, 106.

In one embodiment, the selected provider 104, 106 cooperates with the patient 102 to combine a series of treatments 116 to form a regimen, discussed more below. The regimen is a plan that addresses the patient's immediate concern and prescribes future steps that, if taken, will improve the overall health of the patient 102. The regimen may specify the cooperative treatment of two, three, four, or more of the health care professionals.

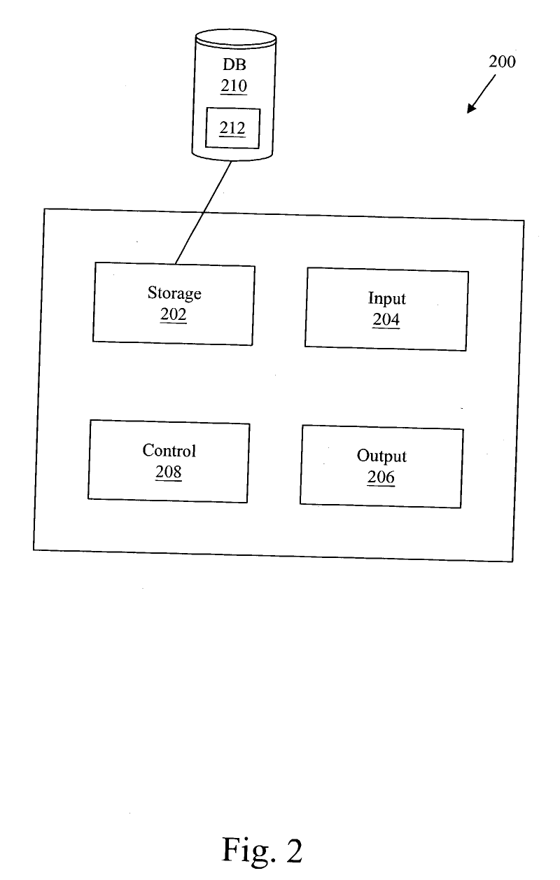

FIG. 2 illustrates a system 200 for delivering comprehensive health care that allows a patient 102 to choose to consult with a medical doctor 104 or one or more AHCPs 106. Of course, the process for implementing the present invention may be accomplished without the system 200. The system 200, however, records, tracks, and monitors patient's progress in accomplishing the goal of complete health in an efficient manner.

The system 200 in the depicted embodiment includes a storage module 202, an input module 204, an output module 206, and a control module 208. Preferably, the system 200 is a database system, meaning that the features and functions of the system 200 are centered on the data in a database 210. The system 200 provides ready access to the database 210 for adding, deleting, and modifying the data.

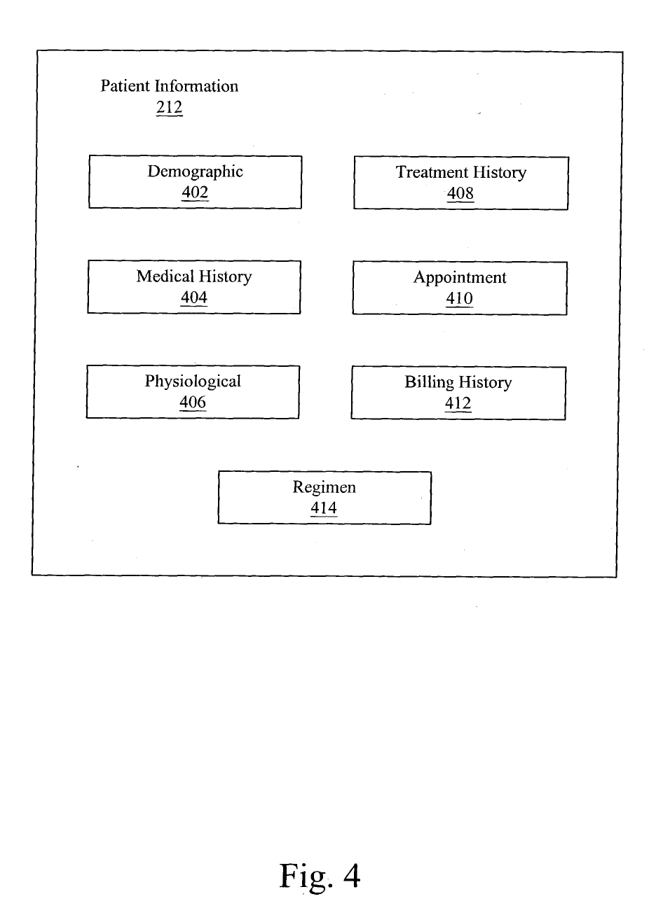

The storage module 202 is configured to store patient information 212. The patient information 212 includes a regimen (See FIG. 4) that is defined cooperatively by the patient 102 and one or more of the doctor 104 and the AHCPs 106. The patient information, described in more detail below, includes all the information necessary to assist the doctor 104 or AHCP 106 in consulting and advising the patient 102.

The storage module 202 retrieves and stores data including patient information in the database 210. Preferably, the storage module 202 performs validation checks prior to storing the data. The storage module 202 may also include module for encrypting data stored in the database 210. In addition, the storage module 202 comprises well known modules (not shown) for allowing a plurality of users to review and modify the data in the database 210 substantially concurrently.

The input module 204 is configured to allow one or more users to concurrently add, delete, and modify patient information 212. Preferably, the input module 204 includes a plurality of Graphical User Interface (GUI) screens including fields that correspond to data elements stored in the database 210. The fields allow for data entry as raw text, drop-down controls, calendar controls, and the like. The input module 204 may validate the data entered for proper formatting, spelling, and the like.

The input module 204 may display the GUI screens on a computer display (not shown). The computer display may comprise a conventional monitor connected to the system 200 by a wired or wireless network. In addition, the computer display may be connected to a conventional computer, a portable computer, a Personal Digital Assistant (PDA), or the like. Preferably, a user may provide data to the input module using conventional input devices such as a mouse, keyboard, and/or touchscreen display. In a preferred embodiment, a user provides information to the input module 204 using a portable computing device.

Similarly, the output module 206 presents patient information 212 and other data from the database 210 to a user using a GUI. GUI screens for the output module 206 may be separate, or integrated with, the GUI screens for the input module 204. Preferably, in accordance with predetermined security rules, the output module 206 may present the patient information 212 to the doctor 104 and one or more AHCPs 106. In certain embodiments, the output module 206 is configured to generate reports summarizing information regarding a plurality of patients 102, doctors 104, and/or AHCPs 106. The output module 206 may communicate with a printer (not shown) to produce hard-copies of information in the database 210.

Preferably, the input module 204 and output module 206 cooperate to allow a plurality of users to interact with the patient information 212. The patient information 212 is maintained in a central location, preferably the database 210, and is provided to one or more users as needed. In this manner, the doctor 104, patient 102, and one or more AHCPs 106 may collaborate in formulating a regimen, diagnosing a condition, or prescribing a treatment 116 for the patient 102.

For example, a patient 102 may consult a doctor 104. The doctor 104 uses the input module 204 to record results of the consultation. The results may include a diagnosis, a lay description of the diagnosis, a fee charged for the consultation, a prescribed treatment, and/or a regimen advised. Next, the patient 102 may go down the hall and consult a massage therapist 106. The input module 204 and output module 206 provide ready access to the results of the previous consultation with the doctor 104 to the massage therapist 106. Furthermore, the providers 104, 106 may access the patient information 212 to track a patient's progress in following a prescribed regimen.

The control module 208 communicates with the storage module 202, the input module 204, and the output module 206. The control module 208 services requests from a user interacting with the input module 204 or output module 206. The control module 208 allows certain users to enter, review, or change predetermined portions of the patient information 212.

Preferably, the control module 208 enforces certain rules regarding collection, storage, maintenance, and review of patient information 212. These rules are consistent with a cooperative relationship 108 between the doctor 104 and one or more AHCPs 106. For example, if the cooperative relationship allows the doctor 104 and one or more AHCPs 106 to review, but not modify, the results of a consultation between a patient 102 and one of the other providers (doctor 104 or AHCPs 106), the control module 208 may direct the output module 206 to display previous consultation results, but prevent the input module 204 from accepting any changes to the previous consultation results.

Of course, the control module 208 may enforce a variety of other business rules defined in the cooperative relationship 108. In certain embodiments, if the cooperative relationship 108 defines specific fee splitting arrangements based on referrals between providers 104, 106, the control module 208 may coordinate splitting and allocating of the fees. Those of skill in the art will readily recognize other business rules that may be enforced using the control module 208. Preferably, the business rules enforced by the control module 208 facilitate the cooperative relationship 108 and encourage the doctor 104 and AHCPs 106 to share professional opinions, patient information, and a common facility in which the system 200 is installed.

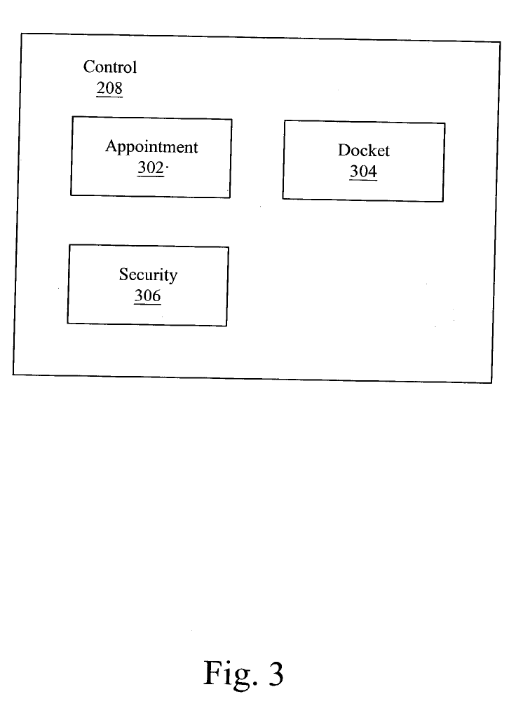

FIG. 3 illustrates certain specific modules that may be included in the control module 208 illustrated in FIG. 2. In certain embodiments, the control module 208 includes an appointment module 302, docket module 304, and security module 306. The appointment module 302 interacts with the input module 204 and the output module 206 to allow a patient to review and revise appointments for consultations with the medical doctor 104 or one of the AHCPs 106.

In one embodiment, the output module 206 presents a calendar that indicates the time slots available for a particular provider 104, 106. The calendar may list open appointment times for all providers 104, 106 or for a selected provider 104, 106. Preferably, the database 210 stores appointment information.

The patient 102, or a receptionist under the direction of the patient 102, interacts with the input module 204 to schedule an appointment with a doctor 104 or an AHCP 106. In one embodiment, the appointment module 302 allows the patient 102 to only schedule consultations with one provider at a time, the doctor 104 or AHCP 106. In other words, the system 200 may not allow the patient 102 to consult with another provider 104, 106 until a currently selected provider 104, 106 provides authorization. In another embodiment, the appointment module 302 allows the patient 102 to consult concurrently with as many providers 104, 106 as desired, but not within the same time slot. In yet another alternative, the appointment module 302 may allow a patient 102 to consult jointly with a doctor 104 and one or more AHCPs 106 during the same time slot. Rules regarding scheduling of consultations may be defined within the control module 208 and may be affected by indicators stored in the patient information 212. Preferences set by the patient 102 in the patient information 212 may limit the appointment options presented. For example, if a patient 102 indicated a preference for male providers 104, 106, the appointment module 302 may filter available appointment slots based on that preference.

In certain embodiments, the input module 204 and output module 206 are configured to allow a patient 102 to access patient information 212 and schedule consultations over the Internet using a web browser. In this manner, a patient 102 may conveniently make and adjust appointments using the appointment module 302 as needed. In addition, providers 104, 106 may use the Internet-enabled input module 204 and output module 206 to review and track patient 102 progress on-line. A patient 102 may use the output module 206 to review a treatment such as an exercise schedule, or an entire regimen.

The docket module 304 provides reminders for the providers 104, 106. Specifically, the docket module 304 provides a periodic reminder for providers 104, 106 to encourage patients 102 to follow prescribed regimens. As discussed above, the regimen comprises one or more treatments such as an educational class, a professional treatment, a subsequent consultation, a self-directed treatment, and the like. The docket module 304 allows providers 104, 106 to provide the necessary follow-up to ensure that patients 102 are successful on following the regimen.

For example, if the regimen includes daily exercise, a few days after a consultation with the exercise physiologist 106, the exercise physiologist 106 may receive a reminder to encourage the patient 102 to do the daily exercise. In response, the exercise physiologist 106 may contact the patient 102 using a preferred contact method such as telephone and provide personal encouragement and follow-up. The reminder may be provided in a variety of formats including e-mail, as part of a list of related reminders, a popup window in the output module 206, or the like.

Alternatively, or in addition, the reminder may be provided to a provider 104, 106 prior to a subsequent consultation with the patient 102. The provider 104, 106 at the subsequent consultation may be with a different provider 104, 106 from the one who originally advised the part of the regimen that gave rise to the reminder. In this manner, the system 200 further assists the providers 104, 106 in collaborating to serve the patient 102.

In one embodiment, the docket module 304 may also provide reminders to the patients 102. The reminders may be notes of encouragement to the patient 102. In addition, the docket module 304 may send a reminder for a subsequent consultation appointment to the patient a few days prior to the schedule appointment. Preferably, the docket module 304 is configured to interface with the output module 206 to provide reminders by way of email, regular mail, through a pre-recorded voice message via a telephone call, and the like. The reminders may be sent according to a preferred contact method indicated in the patient information 212.

The security module 306 serves to control access to the patient information 212. The security module 306 communicates with the input module 204, output module 206, and storage module 202 to protect the patient information 212. Users of the system 202 are preferably associated with a login name and password to identify the user and to determine proper access to patient information 212. Of course, other identification and authorization techniques such as biometric scanners may also be used.

Preferably, the security module 306 enforces a plurality of access levels to the patient information 212. One level may allow for complete access, meaning the user associated with this level is allowed to review, add, delete, and modify patient information 212. In one embodiment, the patient 102 is given this access level. Certain changes, may however, trigger confirmation checks to ensure that the indicated change is intentional.

Another access level may allow the user to review existing patient information 212, enter new patient information 212, but not modify existing patient information 212. In other words, existing patient information 212 is read-only. This access level may be selectively granted to providers 104, 106. In this manner, the provider 104, 106 may enter his/her professional opinion and be assured that another provider 104, 106 cannot modify it. Furthermore, in certain embodiments, access to modify professional opinions entered by providers 104, 106 may also be withheld from the patient 102. Alternatively, certain modifications may be permitted in response to a specific password.

Those of skill in the art will recognize that the access levels may be associated with specific users and/or specific data elements in the database 210. All such variations of access levels recognized by those of skill in the art are considered within the scope of the present invention. Preferably, the access levels are set to instill confidence in the patients 102 and the providers 104, 106 that the security module 306 maintains the recorded information in a manner that encourages cooperation and benefits the patient 102.

In certain embodiments, the patient information 212 may include highly confidential information. For example, a diagnosis may be recorded that carries a high degree of stigma such as AIDS (Acquired Immune Deficiency Syndrome). Alternatively, the patient information 212 may describe an embarrassing condition.

At any time, a patient 102 may request that the security module 306 restrict patient information 212 to only the patient 102. In response to such a request, no other users are allowed to review, add to, or modify the patient information 212. The request may be made using the input module 204. If the patient 102 makes such a request, the security module 306 cooperates with the storage module 202 to encrypt the patient information 212 in the database 210. The encrypted patient information 212 may then be accessible only to the patient 102 using a specific password. While encrypting the patient information 212 may impede the providers 104, 106 ability to collaborate on the patient's behalf, the patient 102, however, receives the desired level of privacy.

In one embodiment, in response to the patient request, only a portion of the patient information 212 is encrypted. For example, the specific diagnosis may be encrypted and password protected. The remainder of the patient information 212 may be available for other providers 104, 106 to review. In this manner, the collaborative efforts of the providers 104, 106 may still assist the patient.

FIG. 4 illustrates one embodiment of patient information 212. Of course, the system 200 may store patient information 212 organized according to a variety of data structures includes database tables, records, arrays, trees, linked lists, or the like.

The patient information 212 includes demographic data 402, medical history data 404, and physiological data 406. Demographic data 402 is basic information for identifying the patient 102. Demographic data 402 includes information such as the patient's name, address, phone number, email address, preferred method of contact for reminders, and the like.

In addition, the demographic data 402 may include basic information related to the patient 102 agreeing to receive health care according to the present invention. For example, the demographic data 402 may include an indicator of whether the patient 102 has received an orientation, consented to a waiver of legal liability of the providers 104, 106, submitted a payment deposit, and/or the like.

Medical history data 404 comprises information regarding the past medical procedures, conditions, and treatments of a patient 102. This may include previous surgeries, illnesses, prescriptions, allergies, and the like. The medical history data 404 assists the providers 104, 106 in making an initial evaluation of the patient 102. Having the patient 102 fill out an intake screen using the input module 204 may provide medical history data 404. Alternatively, the patient 102 may complete a paper intake form that is later transcribed to the system 200.

Physiological data 406 comprises information regarding the current physical condition of the patient's body. Accordingly, the physiological data 406 may be organized chronologically. Physiological data 406 includes information such as height, weight, blood pressure, age, gender, blood type, any physical handicaps, or the like. Physiological data 406 may be updated with each consultation or on a periodic basis.

In addition, the patient information 212 preferably includes treatment history data 408, appointment data 410, and billing history data 412. Preferably, treatment history data 408 is generated as a patient 102 consults with one or more providers 104, 106. During or immediately following a consultation, the selected provider 104, 106 records results for the consultation. As mentioned above, the results may include a simple description of the diagnosis and/or services provided during the consultation, a technical description of the diagnosis and/or services provided, a fee for the consultation and/or the services provided, and the advised treatment 116 for the patient 102. In addition, the treatment history data 408 may identify the provider 104, 106 and the date of the consultation.

In the preferred embodiment, the patient 102 returns for subsequent consultations with the same or a different provider 104, 106. In a subsequent consultation, the provider 104, 106 preferably reviews the treatment history data 408. A different provider 104, 106 may have generated the previous treatment history data 408. Using the previous treatment history data 408, the provider 104, 106 conducting the subsequent consultation formulates a professional opinion regarding a subsequent treatment 116.

By reviewing the previous treatment history data 408, a provider 104, 106 may utilize the experience and judgment of the other providers 104, 106 in formulating his/her own professional opinion. In this manner, the patient 102 receives the benefit of multiple providers 104, 106 in a single facility. In certain embodiments, in addition to using treatment history data 408, the providers 104, 106 may meet periodically to confer about the patients 102 under their care. Based on the conferences, the providers 104, 106 may recommend one or more changes to the regimen for a patient 102.

Appointment data 410 stores information relating to appointments made for consultations and/or treatments between a patient 102 and a provider 104, 106. The appointment data 410 records may include fields such as the time, date, provider 104, 106, a brief description of the purpose of the appointment, and the like.

Billing history data 412 stores information regarding a patient's payments, credits, and debts for services provided by the providers 104, 106. The billing history data 412 includes information such as fees charged, descriptions of the services provided, payments made, and an outstanding balance.

The patient information 212 also includes a regimen 414 for the patient 102. Preferably, the regimen 414 is a combination of treatments that the providers 104, 106 and the patient 102 collectively determine will improve the patient's condition and provide full and complete health. In one embodiment, the regimen 414 includes a timetable that sets forth when the patient 102 is to receive a particular treatment 116. The regimen 414 may comprise a set of textual treatment descriptions linked to a timetable. As mentioned above, the treatment 116 may comprise a subsequent consultation, a procedure, an educational class, or the like.

In certain embodiments, the regimen 414 is a set of goals and sub-goals. For example, one goal may be to reduce the patient's weight by twenty pounds. Sub-goals defined for this goal may be daily exercise, weekly consultations with the nutritionist, and monthly attendance at a healthy eating class. Of course, those of skill in the art will recognize a variety of potential formats for the regimen 414.

Preferably, the regimen 414 may be modified at any time in accordance with the patient's desires and changing condition. Furthermore, providers 104, 106 may prepare a proposal to modify the regimen 414 that is effective once the patient 102 approves. In this manner, the patient 102 controls how and what health care services are delivered.

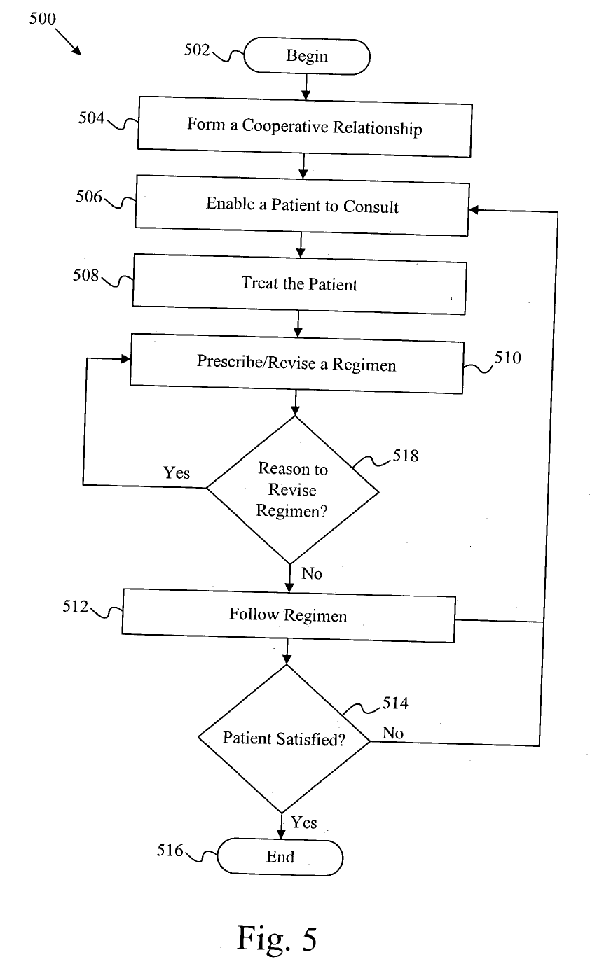

Referring to FIG. 5, a method 500 for delivering comprehensive health care to a patient 102 is illustrated. In one embodiment, a business may implement the method 500 through franchise agreements or other business entities. The method 500 begins 502 by a medical doctor 104 forming 504 a cooperative relationship 108 with at least one AHCP 106. Preferably, the cooperative relationship 108 includes checks and balances to motivate the medical doctor 104 and AHCP 106 to cooperate for the benefit of the patient 102. The medical doctor 104 and AHCP 106 receive patients 102 at a common facility.

The cooperative relationship 108 and common facility enable 506 a patient 102 that comes to the facility to selectively consult with either the medical doctor 104 or one of the AHCPs 106. As part of, or subsequent to, the consultation, the patient 102 is treated 508. In addition, the provider 104, 106 preferably prescribes 510 a regimen 414. If a regimen 414 has been prescribed, the provider 104, 106 may revise the current regimen based on the consultation.

Preferably, the regimen 414 is a plan for assisting the patient 102 in achieving total health and wellness above and beyond the concern that originally caused the patient 102 to seek professional help. Typically, the patient 102 consents to the regimen 414 and begins to follow 512 the regimen 414. Following the regimen 414 may include returning for a subsequent consultation/treatment 508 with the same or a different provider 104, 106.

If, after following the regimen 414 for some period of time, the patient 102 is satisfied 514 with his/her health, the process ends 516 for this patient 102. The providers 104, 106 continue, however, to provide similar services to other patients 102. If the patient 102 is not yet satisfied 514, the patient 102 continues to follow 512 the regimen 414.

In certain circumstances, a reason may arise 518 for revising the regimen 414. For example, the current regimen 414 may be too strenuous for the patient 102. Alternatively, the patient's condition due to the regimen 414 may prompt the patient 102 and/or the provider 104, 106 to revise the regimen 414. One or more providers 104, 106 may confer regarding the patient 102 and agree that, if the patient 102 consents, the regimen 414 should be revised. If a reason to revise the regimen 414 exists 518, the patient 102 works with the provider 104, 106 to revise 510 the regimen 414. If not, the patient 102 continues to follow 512 the regimen 414.

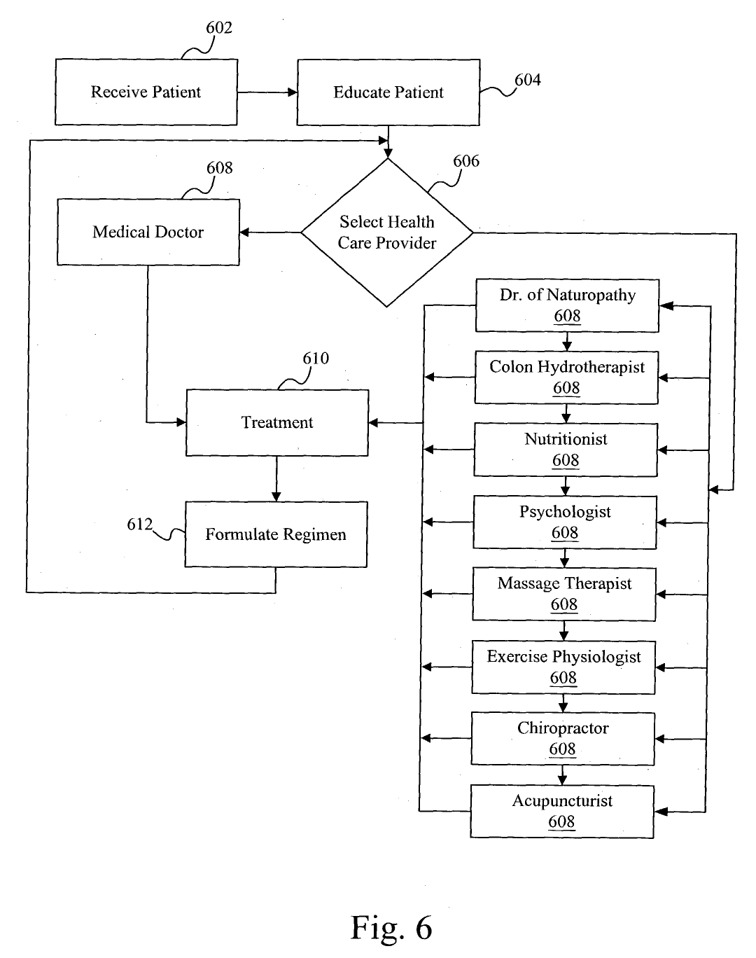

FIG. 6 illustrates a method 600 for delivering comprehensive health care to a specific patient 102. The path the patient 102 takes through the method 600 depends in part on the condition, or concern, the patient 102 seeks to address, and the professional opinions of the providers 104, 106. The ultimate path through the method 600, however, is determined by the desires of the patient 102.

Initially, a facility configured to provide medical services by way of a doctor 104 and at least one AHCP 106 receives 602 a new patient 102. Of course, if the patient 102 presents with an acute trauma condition that is very serious or life threatening, the patient 102 is taken immediately to a hospital. Once such a patient's condition stabilizes, the patient 102 may return to the facility.

Next, the new patient 102 may be educated 604 about the facility and the medical services available from the doctor 104 and the AHCPs 106. The patient 102 decides 606 which health care provider to consult, the doctor 104 or one of the AHCPs 106.

Suppose the patient 102 has a stomach pain with an unknown cause. The patient 102 decides to consult the doctor 104. The doctor 104 consults 608 with the patient 102. During the consultation, the doctor 104 may ask a series of questions, evaluate the patient's body, and conduct some tests. Following the consultation, a treatment 116 is prescribed 610. If the patient 102 has a stomach pain, the doctor 104 may prescribe an ant-acid medicine. Alternatively, the treatment 116 may be administered 610 as part of the consultation.

In addition, the doctor 104 formulates 612 a regimen 414 for the patient 102. The regimen 414 for the patient with stomach pain may include a subsequent consultation with a nutritionist 106 to address the diet of the patient 102. Accordingly, the patient 102 returns to the facility and selects a consultation with the nutritionist 106. Alternatively, the patient 102 may go directly from the doctor's examination room to the nutritionist 106. The nutritionist 106 consults 608 with the patient 102. The nutritionist 106 may provide 610 a treatment such as a meal plan for the patient 102. The nutritionist 106 may then augment 612 the existing regimen 414 by recommending that the patient 102 consult the colon hydrotherapist 106. Alternatively, the regimen 414 may not be changed. Preferably, the patient 102 continues to follow such a cycle consulting one or more of the doctor 104 and AHCPs 106 as needed until the patient 102 determines that he/she has reached an optimal state of health.

In another example, the patient 102 may come to the facility with a concern or need that is not indicative of a disease or ailment. For example, the patient 102 may desire to increase muscle mass. Consequently, the patient 102 may consult 608 with the exercise physiologist 106. The treatment 116 may comprise a weight lifting schedule and the regimen 414 may comprise a subsequent consultation with the nutritionist 608 to address this patient's specific need. In certain embodiments, prior to formulating 612 a regimen 414, the exercise physiologist 106 may confer with the nutritionist 106 to discuss whether the nutritionist 106 can help address the patient's need.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for delivering comprehensive health care to a patient, comprising:
forming a cooperative relationship between a medical doctor and an alternative health care provider for addressing a patient's needs; and
enabling a patient to selectively consult one of the medical doctor and the alternative health care provider to address the patient's needs.

2. The method of claim 1, further comprising:
prescribing a regimen for the patient, the regimen comprising at least one of an educational class, a self-directed treatment, a professional treatment, and a subsequent consultation with one of the medical doctor and the alternative health care provider;
at least one of the medical doctor and the alternative health care provider encouraging the patient to follow the regimen; and
at least one of the medical doctor and the alternative health care provider modifying the regimen in response to patient desires.

3. The method of claim 1, further comprising:
advising the patient to subsequently consult one of the medical doctor and the alternative health care provider;
treating the patient by one of the medical doctor and the alternative health care provider consulted by the patient; and recording patient information to facilitate return consultations between the patient and one of the medical doctor and the alternative health care provider.

4. The method of claim 3, further comprising one of the medical doctor and the alternative health care provider formulating a professional opinion based on patient information comprising professional opinions of one of the medical doctor and the alternative health care provider.

5. The method of claim 6, further comprising protecting patient information in response to a patient request such that access to the patient information is restricted to the patient.

6. The method of claim 1, further comprising recording consultation results for a consultation between the patient and one of the medical doctor and the alternative health care provider.

7. The method of claim 1, wherein the cooperative relationship comprises an agreement between the medical doctor and a plurality of alternative health care providers.

8. The method of claim 1, wherein the cooperative relationship comprises an agreement between the medical doctor and the alternative health care provider to share professional opinions, patient information, and a common facility.

9. A computer system configured to provide for delivery of comprehensive health care that allows patients to choose to consult with one of a medical doctor and one or more alternative health care providers, the system comprising:
a storage module configured to store patient information, the patient information comprising a regimen cooperatively defined by a patient, a medical doctor, and one or more alternative health care providers;
an input module configured to maintain patient information;
an output module configured to present patient information to the medical doctor and one or more alternative health care providers; and
a control module in communication with the storage module, input module, and output module and configured to manage the patient information to support a cooperative relationship between a medical doctor and one or more alternative health care providers for addressing a patient's needs.

10. The computer system of claim 9, further comprising an appointment module configured to allow a patient to selectively schedule a consultation with one of the medical doctor and one or more of the alternative health care providers.

11. The computer system of claim 9, further comprising a security module configured to protect patient information in response to a patient request such that access to the patient information is restricted based on a password.

12. The computer system of claim 9, wherein the one or more of the alternative health care providers are selected from the group consisting of a naturopathy doctor, a colon hydrotherapist, a nutritionist, a psychologist, a massage therapist, an exercise physiologist, a chiropractor, and an acupuncturist.

13. The computer system of claim 9, further comprising a docketing module configured to remind one of the medical doctor and the one or more alternative health care providers to encourage the patient to follow the regimen, the regimen comprising at least one of an educational class, a self-directed treatment, a professional treatment, and a subsequent consultation.

14. The computer system of claim 9, wherein the input module is configured to allow one of the medical doctor and one or more of the alternative health care providers to review and augment the patient information with results of a consultation with the patient.

15. The computer system of claim 9, wherein the control module facilitates a cooperative relationship defined in an agreement between the medical doctor and the one or more alternative health care providers to share professional opinions, patient information, and a common facility.

16. A method for delivering comprehensive health care to a patient, comprising:
receiving a patient at a facility configured to provide medical services by way of a medical doctor and at least one alternative health care provider;
enabling the patient to consult with one of the medical doctor and the at least one alternative health care provider; and
formulating a regimen for the patient to achieve complete health care that includes one or more treatments from one or more of the medical doctor and the at least one alternative health care provider.

17. The method of claim 16, further comprising:
educating the patient about the medical services available from the medical doctor and at least one alternative health care provider; and
tracking a patient's progress following the regimen.

18. The method of claim 16, wherein the regimen comprises consultations between the patient and one or more of the medical doctor and the at least one alternative health care provider.

19. The method of claim 16 further comprising conferring between the medical doctor and the at least one alternative health care provider regarding adjustments to the regimen.

20. The method of claim 16, further comprising providing an incentive program for the medical doctor and the at least one alternative health care provider to cooperate to address the patient's needs.
